(19) United States
(12) Patent Application Publication
(10) Pub. No.: US 2026/0124809 A1
(43) Pub. Date: May 7, 2026

(54) METHOD FOR PROVIDING LAYER IMAGE FOR 3D PRINTING, AND DEVICE FOR IMPLEMENTING SAME

(71) Applicant: OSSTEM IMPLANT CO., LTD., Seoul (KR)

(72) Inventors: Sang Youn KIM, Goyang-si (KR); Jin Hoon LEE, Hanam-si (KR); Jae Kyung SON, Incheon (KR)

(21) Appl. No.: 19/118,742

(22) PCT Filed: Sep. 13, 2023
(86) PCT No.: PCT/KR2023/013706

§ 371 Date: Apr. 4, 2025

(30) Foreign Application Priority Data
Oct. 5, 2022 (KR) 10-2022-0126695

(51) Int. Cl. B29C 64/393; B29C 64/129; B29C 64/286; B33Y 10/00; B33Y 50/02

(52) U.S. Cl. CPC B29C 64/393; B29C 64/129; B29C 64/286; B33Y 10/00; B33Y 50/02

(57) ABSTRACT

A method performed by a computing system according to one embodiment of the present disclosure, comprises the steps of: determining a masking area of a current layer on the basis of a non-overlapping area between the current layer and at least one previous layer from among a plurality of layers; and updating an image of the current layer in accordance with a user input for setting a light exposure amount with respect to the masking area of the current layer, wherein the plurality of layers are designed to sequentially cure a photocurable material in each layer unit for 3D printing.

### TECHNICAL FIELD

The present invention relates to a method of providing a layer image for 3D printing and a device for implementing the same, and more specifically, to a method of providing a layer image for 3D printing which can provide a function for setting a light exposure amount when configuring a plurality of layer images for 3D printing in dental software and a device for implementing the same.

### BACKGROUND ART

3D outputs by 3D printers are implemented by repeatedly stacking layers with a certain thickness, and output for each layer is performed by hardening a light cured resin through light irradiation, such as the use of Ultraviolet Rays (UV). In the case of dental 3D printers, outputs for the production of implants or prosthetics can be obtained in the same manner as mentioned above.

When a layer image for 3D printing is designed using software, a set of 2D layer images is configured by performing tomography based on units of the thickness of the layer of a 3D model. Accordingly, the output for each layer is obtained using the set of 2D layer images designed by the software.

However, when the set of layer images on the software is configured, since tomography is performed without taking into consideration the amount of UV transmission between the previous and next layers, over-curing may occur in the vicinity of the boundary of a layer that is continuously exposed to UV light at the time of the output of each layer.

To solve this problem, a method of calculating the amount of UV transmission in real time when printing each layer is performed by a 3D printer can be considered, but for real-time operation, an increase in the cost related to improving the CPU processing performance is unavoidable. In addition, there is a problem in that the output time increases because the processing speed for real-time operation is reduced.

Therefore, a technology is required that can configure a set of layer images by taking into consideration the amount of UV transmission so that over-curing does not occur in the output layer without lowering the processing performance of the 3D printer.

### DETAILED DESCRIPTION OF THE INVENTION

### Technical Problem

The present invention is directed to providing a method of providing a layer image for 3D printing that can design a plurality of layer images so that over-curing caused by UV light does not occur in the vicinity of the boundary of a layer at the time of output of each layer in a 3D printer, and a device for implementing the same.

The present invention is also directed to providing a method of providing a layer image for 3D printing that can configure masking information for controlling the light exposure amount in some areas of a layer image when a plurality of layer images for 3D printing is configured by dental software, and a device for implementing the same.

The present invention is also directed to providing a method of providing a layer image for 3D printing that can configure masking information by comparing the output areas of a current layer and a previous layer when a plurality of layer images for 3D printing is configured by dental software, and a device for implementing the same.

The technical problems of the present disclosure are not limited to the technical problems mentioned above, and other technical problems not mentioned will be clearly understood by those skilled in the art based on the description below.

### Technical Solution

One aspect of the present invention provides a method performed by a computing system according to an embodiment of the present disclosure. The method includes determining a masking area of a current layer based on a non-overlapping area between a current layer and at least one previous layer from among a plurality of layers; and updating an image of the current layer by setting a light exposure amount of the masking area of the current layer, wherein the plurality of layers are designed to sequentially stiffen a photocurable material with respect to a unit of each layer for 3D printing.

In one embodiment, the determining of the masking area of the current layer may include determining the masking area based on an area of the output area of the current layer that overlaps with an non-output area of the at least one previous layer.

In one embodiment, the determining of the masking aera of the current layer may include determining the masking area based on a change in the expansion of the output area of the current layer compared to the output area of the at least one previous layer.

In one embodiment, the determining of the masking area of the current layer may include setting at least a portion of the non-output area of the at least one previous layer as an over-curing area when the output area of the current layer protrudes further outward than the output area of the at least one previous layer and determining as the masking area an output area in which UV light transmitted through a corresponding output area from the output area of the current layer reaches the over-curing area of the at least one previous layer and causes curing.

In one embodiment, the determining of the masking area of the current layer may include determining the number of the at least one previous layers to determine the masking area.

In one embodiment, the determining of the number of the at least one previous layers for determining the masking area may include calculating the number of the at least one previous layers using a thickness of a material that is stiffened by a maximum light exposure amount and a stacking thickness corresponding to one layer.

In one embodiment, the updating of the image of the current layer may include setting the light exposure amount with respect to the masking area of the current layer as a predetermined grayscale value.

In one embodiment, the method may further include providing a UI that displays a plurality of layer images in which the masking area is displayed, respectively; and displaying the layer image selected by a user input among the plurality of layer images displayed on the UI by enlarging or reducing the selected layer image while displaying the masking area in the selected layer image so that the masking area is identifiable.

Another aspect of the present invention provides a computing system. The computing system may include one or more processors, a communication interface configured to communicate with an external device, a memory configured to load a computer program executed by the processor, and a storage configured to store the computer program, wherein the computer program includes instructions for performing operations of: determining a masking area of a current layer based on a non-overlapping area between a current layer and at least one previous layer from among a plurality of layers; and updating an image of the current layer by setting a light exposure amount of the masking area of the current layer, wherein the plurality of layers are designed to sequentially stiffen a photocurable material in each layer unit for 3D printing.

In one embodiment, the determining of the masking area of the current layer may include determining the masking area based on an area of the output area of the current layer that overlaps with a non-output area of the at least one previous layer.

In one embodiment, the determining of the masking aera of the current layer may include determining the masking area based on a change in the expansion of the output area of the current layer compared to the output area of the at least one previous layer.

In one embodiment, the determining of the masking area of the current layer may include setting at least a portion of the non-output area of the at least one previous layer as an over-curing area when the output area of the current layer protrudes further outward than the output area of the at least one previous layer and determining as the masking area an output area in which UV light transmitted through a corresponding output area from the output area of the current layer reaches the over-curing area of the at least one previous layer and causes curing.

In one embodiment, the determining of the masking area of the current layer may include determining the number of the at least one previous layers to determine the masking area.

In one embodiment, the determining of the number of the at least one previous layers for determining the masking area may include calculating the number of the at least one previous layers using a thickness of a material that is stiffened by a maximum light exposure amount and a stacking thickness corresponding to one layer.

In one embodiment, the updating of the image of the current layer may include setting the light exposure amount with respect to the masking area of the current layer as a predetermined grayscale value.

### Advantageous Effects

As described above, according to the present disclosure, at the time of output of each layer in a 3D printer, UV light transmitted through the current layer is transmitted to the previous layer, which can prevent over-curing caused by duplicate curing.

In addition, according to the present disclosure, when a plurality of layer images for 3D printing is designed by dental software, an area where UV light transmission should be incident for each layer can automatically be obtained through area comparison of the output areas of the current layer and the previous layers.

Moreover, according to the present disclosure, at the time of output of each layer using a 3D printer, the quality of a 3D output can be improved without incurring additional costs caused by improving computational performance or increasing the output time.

### BRIEF DESCRIPTION OF THE DRAWINGS

FIG. 1 is a diagram illustrating a system according to an embodiment of the present disclosure.

FIG. 2 is a flowchart illustrating a method of providing a layer image for 3D printing according to the embodiment of the present disclosure.

FIG. 3 illustrates an example of generating a set of 2D layer images from a 3D model according to some embodiments of the present disclosure.

FIG. 4 is a vertical cross-sectional view illustrating a plurality of layers sequentially hardened by UV light according to the conventional art.

FIG. 5 is a vertical cross-sectional view illustrating an area where over-curing may occur among non-output areas of each layer according to the conventional art.

FIG. 6 is a flowchart specifically illustrating the detailed operation of operation S11 described in FIG. 2.

FIG. 7 is a horizontal cross-sectional view illustrating an example of determining a masking area of a current layer by comparing output areas of the current layer with previous layers according to some embodiments of the present disclosure.

FIG. 8 is a horizontal cross-sectional view illustrating an example of setting as a gray scale value the light exposure amount for a masking area of each layer determined in FIG. 7.

FIGS. 9 and 10 are vertical and horizontal cross-sectional views illustrating an embodiment showing whether a mask is applied according to an area change of each layer according to some embodiments of the present disclosure.

FIG. 11 illustrates an example of calculating the number of previous layers required for mask application of a current layer according to some embodiments of the present disclosure.

FIG. 12 is a flowchart specifically illustrating an additional operation performed after operation S12 described in FIG. 2.

FIG. 13 illustrates an example of a UI that displays a plurality of layer images to which a mask is applied according to some embodiments of the present disclosure.

FIG. 14 is an example showing previous layers inspected for mask application of an image of a current layer in a pop-up window according to some embodiments of the present disclosure.

FIG. 15 is a block diagram illustrating hardware of a computing system according to another embodiment of the present disclosure.

### MODES OF THE INVENTION

Hereinafter, preferred embodiments of the present invention will be described in detail with reference to the drawings. The advantages and features of the present disclosure and the methods for achieving them will become clear by referencing the embodiments described in detail below. However, the present disclosure is not limited to the embodiments disclosed below but may be implemented in various different forms, these embodiments are provided only to make the present disclosure complete and fully inform a person having ordinary skill in the art to which the present disclosure belongs of the scope of the invention, and the present disclosure is defined only by the scope of the claims.

In describing the present disclosure, if it is determined that a detailed description of a related known configuration or function may obscure the gist of the present disclosure, the detailed description thereof will be omitted.

Hereinafter, some embodiments of the present disclosure are described in detail with reference to the attached drawings.

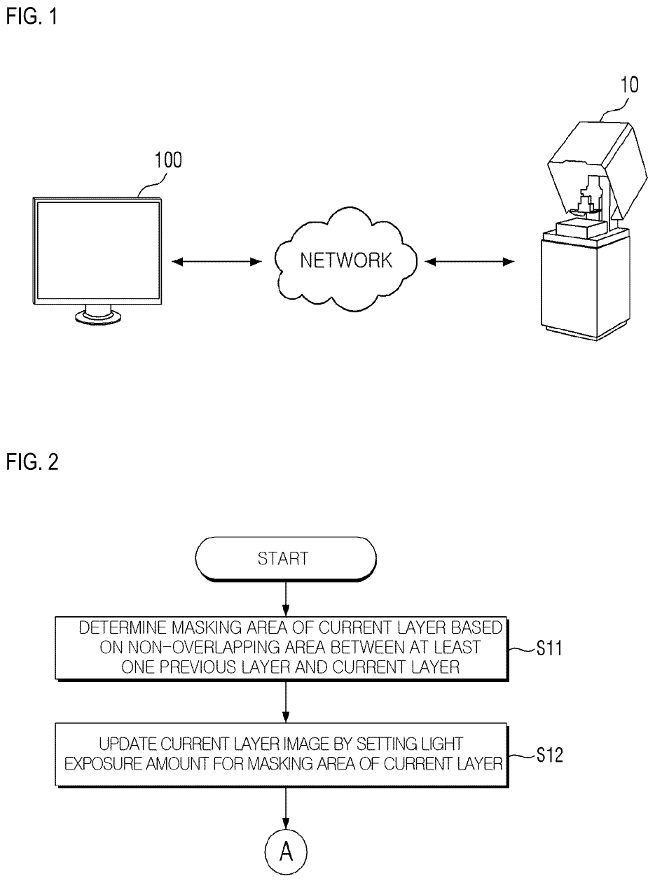

FIG. 1 is a diagram illustrating a system according to an embodiment of the present disclosure. Referring to FIG. 1, the system according to the embodiment of the present disclosure includes a computing system 100 and a 3D printer 10, and the computing system 100 is connected to the 3D printer 10 via a network.

The 3D printer 10 performs output for each layer by curing a light cured resin through light irradiation such as UV. At this time, the computing system 100 generates a plurality of layer images and provides them to the 3D printer 10 so that the 3D printer 10 can perform output of each layer.

The computing system 100 provides a user interface for generating a plurality of layer images to be provided to the 3D printer 10.

The computing system 100 determines and displays a masking area for each layer based on a non-overlapping area between each layer and the previous layers when generating the plurality of layer images. At this time, the masking area is a partial area of the entire output area of each layer for controlling a light exposure amount, such as UV, when outputting each layer by the 3D printer 10.

The computing system 100 may set the light exposure amount for the masking area of each layer to be lower than a reference value. At this time, the light exposure amount set for the masking area can be set to a value previously stored through environment settings. As an example, the computing system 100 may display the light exposure amount for the masking area by applying as a grayscale value the light exposure amount within a predetermined range stored previously. In addition, the light exposure amount for the masking area may be set according to user input.

Accordingly, when generating the plurality of layer images, the computing system 100 may update each layer image by setting the light exposure amount for the masking area designated for each layer and provide each the updated layer image to the 3D printer 10.

According to the system configuration of the present disclosure as described above, when configuring the plurality of layer images for 3D printing, by configuring masking information for controlling the light exposure amount in some areas of the layer images, over-curing due to duplicate curing can be prevented from occurring in the vicinity of the boundary of the layers.

FIG. 2 is a flowchart illustrating a method of providing a layer image for 3D printing according to an embodiment of the present disclosure.

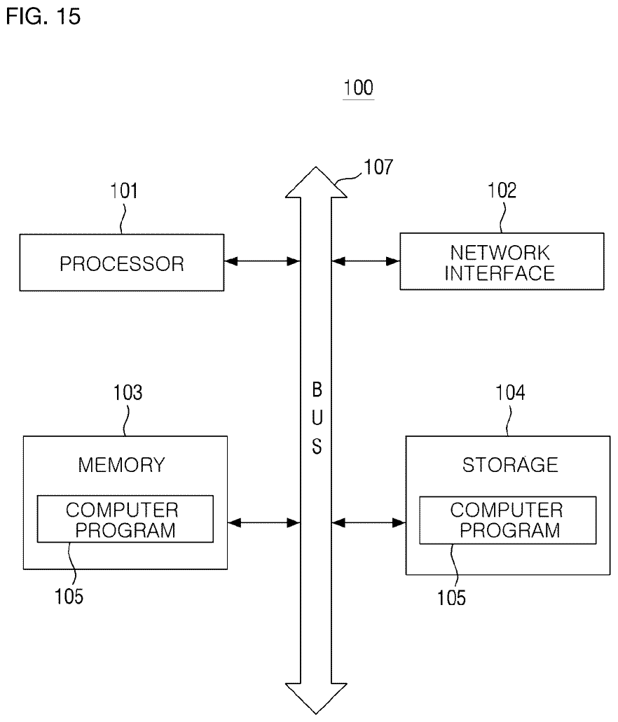

The method of providing a layer image for 3D printing according to the present embodiment may be performed by one or more computing systems (see reference numeral 100 of FIG. 15). In other words, the method of providing a layer image for 3D printing according to the present embodiment may perform all operations by one computing system, or some operations may be performed by other computing systems. For example, some operations may be performed by a terminal device, and other operations may be performed by a server device. In addition, since the server device is implemented on a cloud computing node, operations performed by the server device may also be divided and performed on multiple cloud computing nodes. Hereinafter, in describing the method according to the present embodiment, descriptions of a subject to perform some operations may be omitted. In this case, it should be understood that a subject to perform the corresponding operation is the computing system 100.

The computing system 100 may be a system in which dental software for generating a plurality of layer images that should be provided to the 3D printer 10 to output implants or prosthetics is equipped and executed.

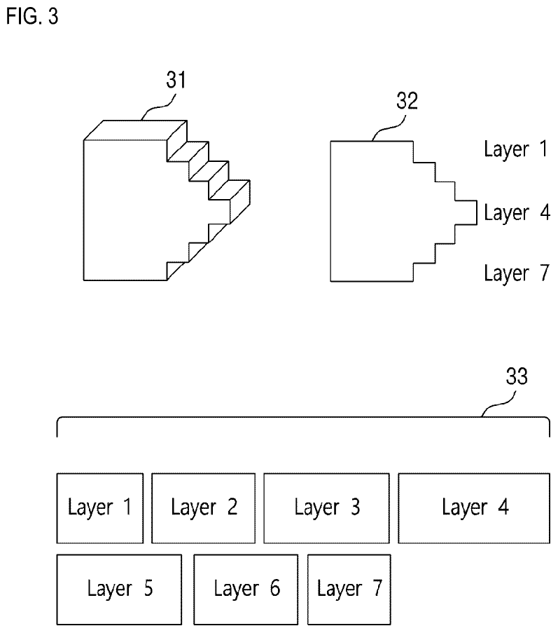

Prior to the description of FIG. 2, as shown in FIG. 3, the computing system 100 generates a plurality of 2D layer images 33 corresponding to a 3D object 31 in software in order to output a 3D object 31 from the 3D printer 10. At this time, the plurality of 2D layer images 33 may be generated by slicing a shape 32 generated by cutting a cross-section of the 3D object 31 according to a predetermined thickness unit.

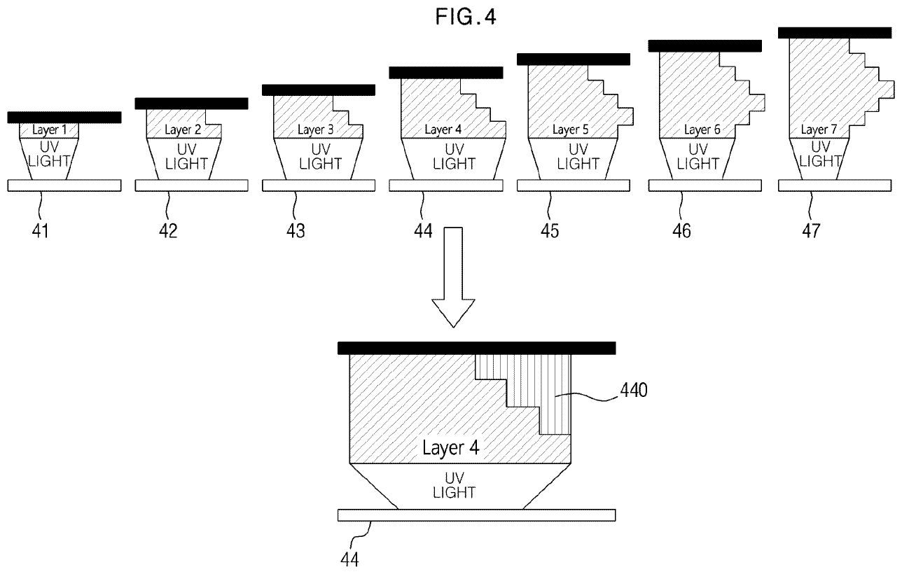

Referring to the conventional art illustrated in FIG. 4, the 3D printer 10 sequentially performs UV curing 41-47 from the cross-section of a first layer Layer 1 to the cross-section of a seventh layer Layer 7 using the plurality of 2D layer images 33 provided from the computing system 100 to stiffen a resin material through a UV light irradiation method of outputting the 3D object 31.

At this time, in a case in which the cross-section of a fourth layer Layer 4 is stiffened as shown in 44, when the output area of the fourth layer Layer 4 protrudes further outward than the output areas of the previous layers Layer 1, Layer 2, and Layer 3, according to the conventional art, an over-curing area 440 that is repeatedly stiffened due to UV light transmitted through the fourth layer Layer 4 may occur in the previous layers Layer 1, Layer 2, and Layer 3. In the example illustrated in FIG. 4, the over-curing area 440 is illustrated as a range corresponding to the entire non-output areas of the previous layers Layer 1, Layer 2, and Layer 3 but may be formed in a partial range of the non-output areas of the previous layers depending on the intensity of the UV light transmitted through the fourth layer Layer 4. In an embodiment, the over-curing area 440 may be formed mainly in the vicinity of the boundary of the previous layers Layer 1, Layer 2, and Layer 3.

Since the over-curing area 440 has a negative effect on the exterior quality of the final output of the 3D printer 10, it is necessary to suppress the occurrence of the over-curing area 440 to improve the quality of the final output.

For the above reasons, the computing system 100 may perform operations S11 and S12 illustrated in FIG. 2 to design the plurality of layer images so that over-curing caused by UV curing does not occur.

Referring to FIG. 2, first, in operation S11, the computing system 100 determines and displays the masking area of the current layer based on the non-overlapping area between the current layer and the at least one previous layer among the plurality of layers designed to be sequentially stiffened in units of layers for 3D printing.

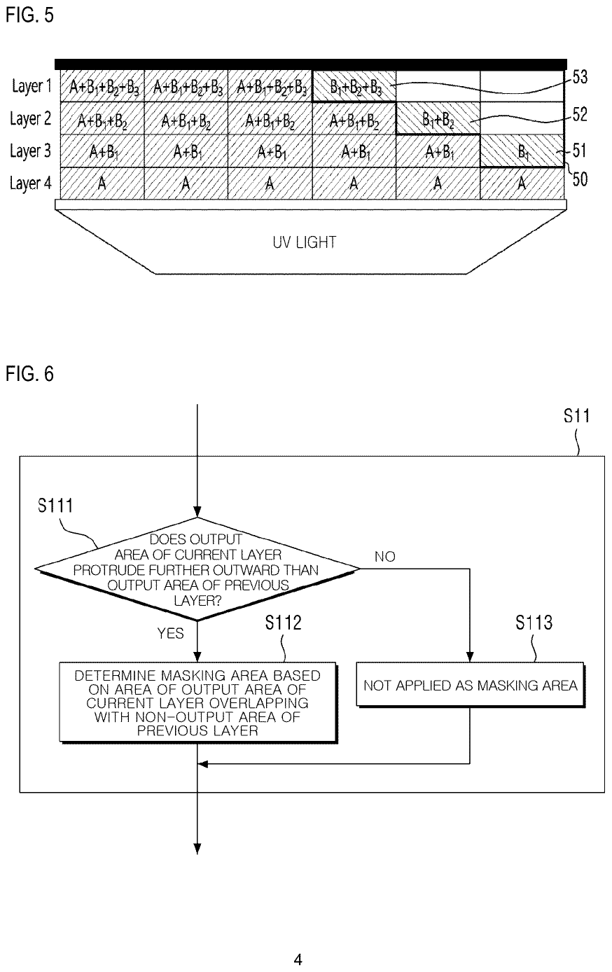

In the example of the conventional art illustrated in FIG. 5, in a case in which UV light is irradiated, when the light energy per unit area of the fourth layer Layer 4 that is transmitted through the bottom layer is A, and the light energy transmitted through the first, second, and third layers Layers 1, 2, and 3 are B₁, B₂, and B₃, respectively, the light energy corresponding to B₁+B₂+B₃ (53), B₁+B2 (52), and B₁ (51) is transmitted to some of the boundaries so that over-curing may occur although there is no need for UV light to be transmitted to the non-output areas 50 of the first layer Layer 1, the second layer Layer 2, and the third layer Layer 3.

At this time, according to the embodiment of the present disclosure, the computing system 100 may configure an area of the entire area of the fourth layer Layer 4 that does not overlap with the previous layers as the masking area to prevent over-curing from occurring in the vicinity of a portion of the boundary of the non-output area 50 of the previous layers.

As an example, referring to FIG. 6, operation S11 may include detailed operations S111 to S113.

The computing system 100 determines whether the output area of the current layer protrudes further outward than the output area of the previous layer in operation S111, and when it is determined that the output area of the current layer protrudes further outward than the output area of the previous layer, in operation S112, the computing system 100 determines the masking area based on an area of the output layer of the current layer that overlaps with the non-output area of the previous layer.

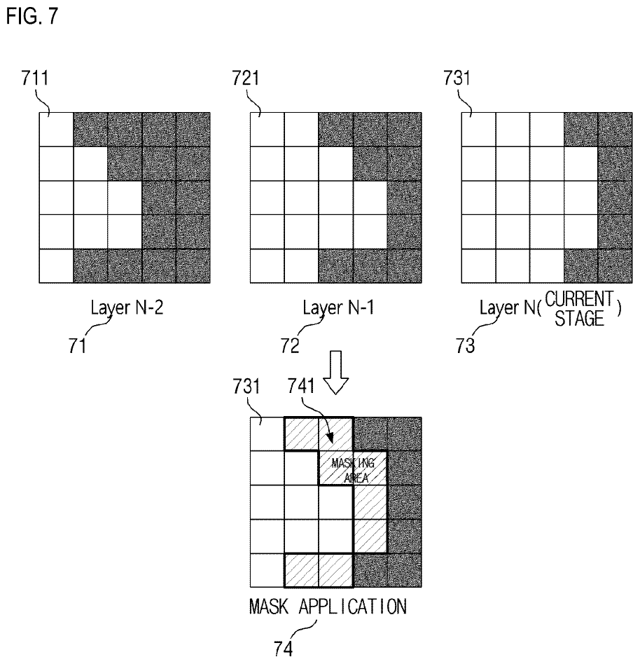

For example, as illustrated in FIG. 7, the computing system 100 may determine a masking area of a current layer Layer N 73 by examining the current layer Layer N 73 and the previous layers Layer N-2 71 and Layer N-1 72.

At this time, among white pixel coordinates of an output area 731 of the current layer Layer N 73, the positions of pixel coordinates that do not overlap with output areas 711 and 721 of the previous layers Layer N-2 71 and Layer N-1 72 may be designated as a masking area 741. In other words, among the white pixel coordinates of the output area 731 of the current layer Layer N 73, the positions of the pixel coordinates that overlap with black pixel coordinates of the non-output areas of the previous layers Layer N-2 71 and Layer N-1 72 may be the masking area 741.

As another example, in operation S111, when the computing system 100 determines that the area of the output area of the previous layer is larger or equal to the area of the output area of the current layer, in operation S113, the computing system 100 may not apply the masking area of the current layer.

Next, after operation S11 is performed in FIG. 2, in operation S12, the computing system 100 updates the image of the current layer by setting the light exposure amount with respect to the masking area of the current layer.

In the embodiment, when the masking area is determined for each layer, the computing system 100 may set the light exposure amount of the corresponding masking area. At this time, the light exposure amount may be set using a grayscale value.

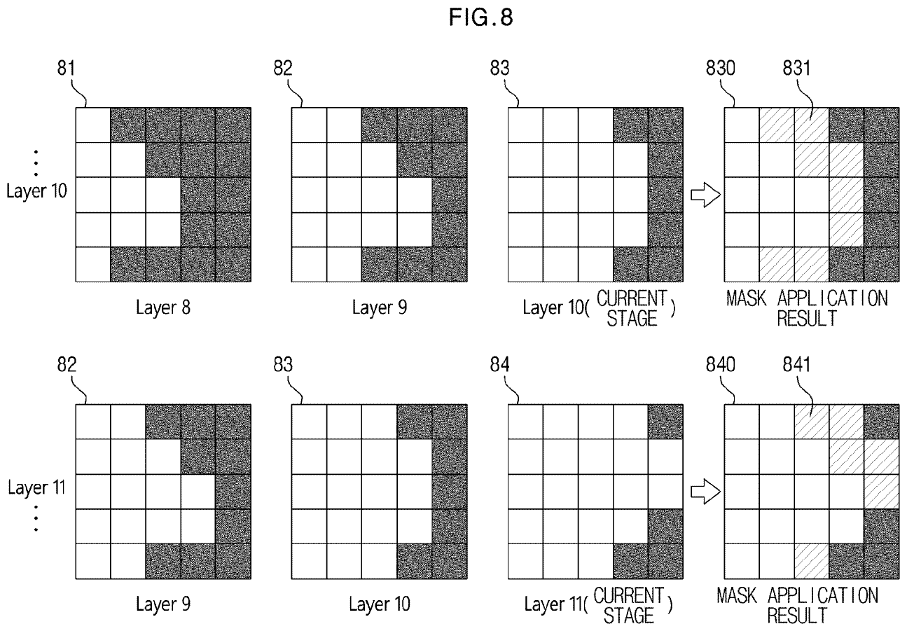

For example, as illustrated in FIG. 8, when generating an image of a tenth layer Layer 10, the computing system 100 may display a non-overlapping area as a masking area 831 of the tenth layer 83 by comparing the output area of the tenth layer 83 with the output areas of previous layers 81 and 82. Similarly, when generating an image of an eleventh layer Layer 11, the computing system may display a non-overlapping area as a masking area 841 for the eleventh layer 84 by comparing the output area of the eleventh layer 84 with the output areas of the previous layers 82 and 83.

At this time, the computing system 100 may set the light exposure amounts of the masking area 831 of the tenth layer 83 and the masking area 841 of the eleventh layer 84 to be lower than a reference value. In an exemplary embodiment, the gray scale value may be set to a value that can sufficiently stiffen the current layer while minimizing the amount of light that is transmitted through the current layer and reaches the previous layer.

For example, the computing system 100 may set the light exposure amount to a gray scale value within a predetermined range in order to set the light exposure amounts of the masking areas 831 and 841 to be low. At this time, the gray scale value is set to correspond to a limited light exposure amount to be irradiated for the pixels of the masking areas 831 and 841 while performing 3D printing and may be designated as a value between the minimum value and the maximum value that can be set on the computing system 100. For example, when the minimum value of the gray scale that can be set on the computing system 100 is 0 and the maximum value thereof is 255, the gray scale values of the masking areas 831 and 841 may be designated as values between 0 and 255. In addition, the gray scale value may automatically be set to a value (e.g., 120) that is stored in advance or may be set to a predetermined range, such as a value between 50 and 200 or a value between 100 and 155, through user input.

According to the above embodiment, the computing system 100 may update each layer image in 830 and 840 by setting gray scale values corresponding to the light exposure amounts of the masking areas 831 and 841 designated for each layer 83 or 84 and provide each updated layer image to the 3D printer 10. In addition, by setting the light exposure amounts of the masking areas 831 and 841 to be lower than the reference value, the amount of light energy transmitted to the previous layer by penetrating the current layer is reduced, so that over-curing may be prevented from occurring at the boundaries of the previous layers.

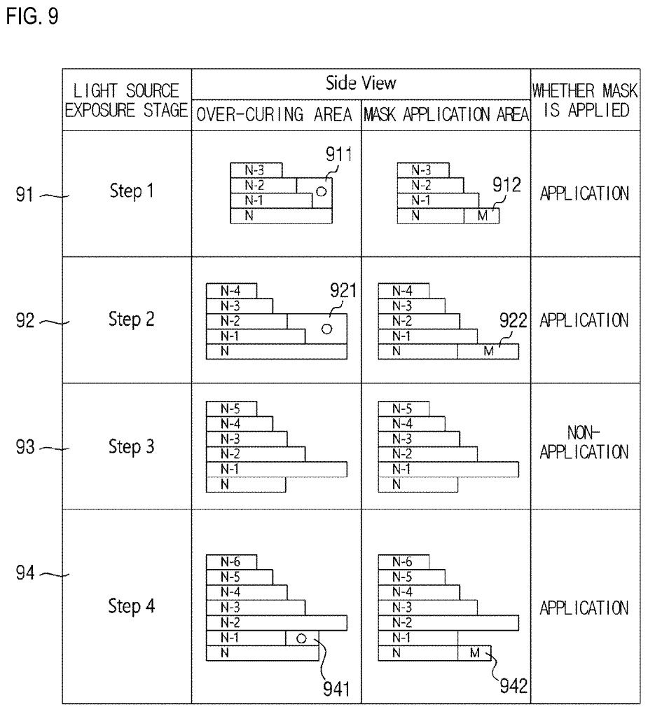

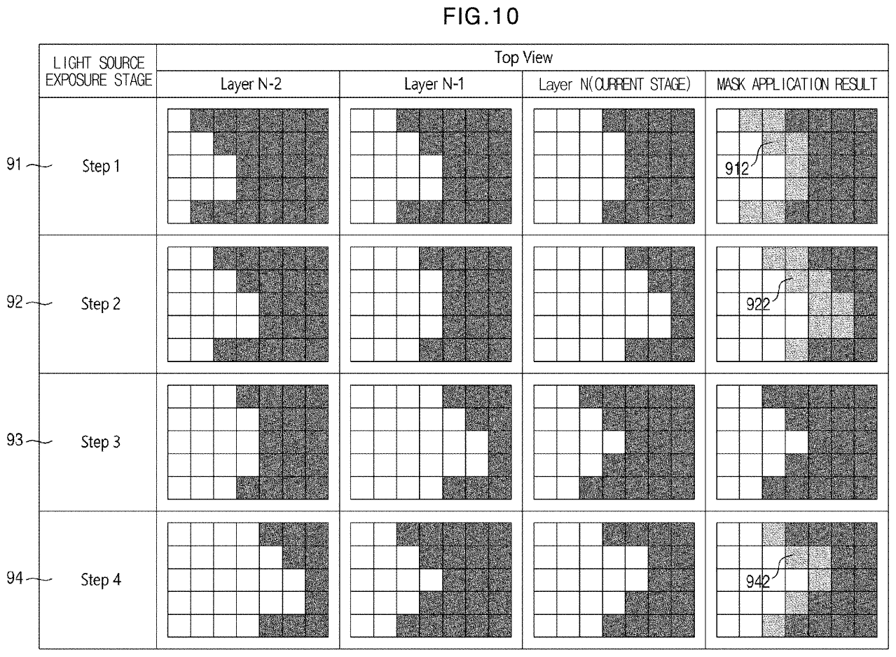

In the embodiment, the computing system 100 may determine the masking area based on a change in the expansion of the output area of the current layer compared to the output area of the at least one previous layer. As an example, referring to FIGS. 9 and 10, the computing system 100 may determine whether to apply the masking area based on a change in the area of the output area of each layer.

The example of FIG. 9 shows a cross-section in which multiple layers are sequentially stiffened through UV light exposure. At this time, it is assumed that the number of layers irradiated for application of the masking area of each layer is 2 layers.

First, in Step 1 91, when the output area of an N-th layer protrudes further outward than the output areas of a (N-1)-th layer and a (N-2)-th layer Layers N-1 and N-2, at least a portion of the non-output areas of the (N-1)-th and (N-2)-th layers Layers N-1 and N-2 may be set as an over-curing area 911. At this time, from the entire area of the N-th layer, an area overlapping with the over-curing area 911 may be determined as a masking area 912.

Next, in Step 2 92, UV curing of a new layer is performed, and thus, the N-th layer of Step 1 91 is changed to the (N-1)-th layer Layer N-1. At this time, the non-output areas of the N-th layer and (N-1)-th layer, which have a smaller area than the N-th layer that is the new layer, may be set as an over-curing area 921. At this time, from the entire area of the N-th layer, an area overlapping with the over-curing area 921 may be determined as a masking area 922.

Next, in Step 3 93, since the output area of the N-th layer of the new layer does not protrude further outward than the output areas of the the (N-1)-th layer and (N-2)-th layer, there is no over-curing area in the non-output areas of the (N-1)-th layer and (N-2)-th layer. In this case, there is no need to designate a masking area on the N-th layer.

Finally, in Step 4 94, since the output area of the layer N of the new layer protrudes further outward than the output area of the (N-1)-th layer, the non-output area of the (N-1)-th layer may be set as an over-curing area 941. At this time, from the entire area of the N-th layer, an area overlapping with the over-curing area 941 may be determined as a masking area 942.

The example of FIG. 10 is a top view illustrating the entire pixel coordinates of each layer in Step 1 91 to Step 4 94 described in FIG. 9.

In Step 1 91, the masking area 912 may be displayed by a position of pixel coordinates, which overlaps with the over-curing areas (reference numeral 911 of FIG. 9) of the (N-1)-th layer and (N-2)-th layer Layers N-1 and N-2, among the entire pixel coordinates of the N-th layer Layer N.

Similarly, in Step 2 92, the masking area 922 may be displayed by a position of pixel coordinates, which overlaps with the over-curing areas (reference numeral 921 of FIG. 9) of the (N-1)-th layer and (N-2)-th layer Layers N-1 and N-2, among the entire pixel coordinates of the N-th layer Layer N. In addition, in Step 4 94, the masking area 942 may be displayed at a position of pixel coordinates, which overlaps with the over-curing area (reference numeral 941 of FIG. 9) of the (N-1)-th layer Layer N-1, among the entire pixel coordinates of the N-th layer Layer N.

In the case of Step 3 93, since the output areas of the (N-1)-th layer and (N-2)-th layer Layers N-1 and N-2 protrude further outward than the output area of the N-th layer Layer N, there is no over-curing area in the (N-1)-th layer and (N-2)-th layer Layers N-1 and N-2, and therefore, the masking area is not displayed on the entire pixel coordinates of the N-th layer Layer N.

In the embodiment, the computing system 100 may determine the number of at least one previous layers that needs to be irradiated in order to determine the masking area of the current layer. At this time, the computing system 100 may calculate the number of previous layers that needs to be irradiated using the thickness of a material that is stiffened by the maximum light exposure amount and the stacked thickness corresponding to one layer. In addition, the computing system 100 may additionally take into consideration the transmittance of the light source of the 3D printer 10 to determine the number of previous layers. The transmittance of the light source may have a different ratio depending on the intensity of the light source, the exposure time, and the stiffening characteristics of the material for each 3D printer product.

In the embodiment, the number of previous layers that needs to be inspected may be calculated and stored before determining the masking area for each layer.

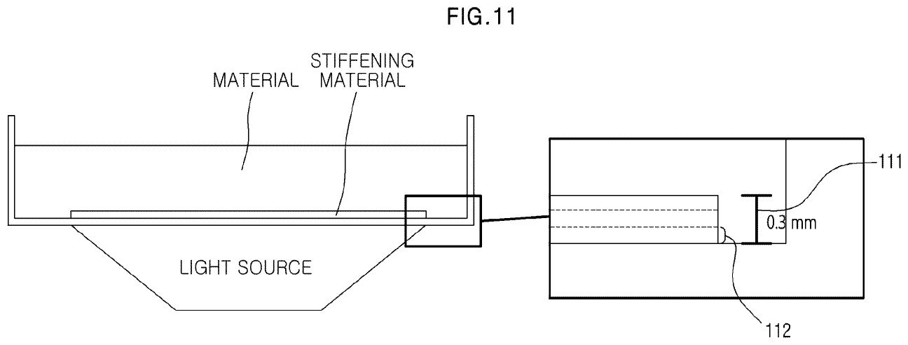

Referring to FIG. 11, first, in the 3D printer 10, a thickness Tᵣ of a material of one layer stiffened by exposing the material to a light source for a predetermined curing time is measured. At this time, a value Tᵢ=(Tᵣ/Tₛ)−1 obtained by dividing the thickness Tᵣ of the stiffened material by a predetermined stacking thickness Tₛ of the layer and then subtracting 1, which is the number of the current layers, from the divided value may be determined as the number of previous layers that needs to be inspected for determining the masking area.

In the illustrated example, since a thickness Tᵣ 111 of the stiffened material is 0.3 mm and a stacking thickness Tₛ 112 of the layer is 0.1 mm, the number Tᵢ of previous layers that needs to be inspected for determining the masking area is 0.3/0.1−1=2 (layers). As another example, since the thickness Tᵣ 111 of the stiffened material is 0.4 mm and the stacking thickness Tₛ 112 of the layer is 0.05 mm, the number Tᵢ of previous layers that needs to be inspected to determine the masking area is 0.4/0.05−1=7 (layers).

The computing system 100 may receive and store the number of previous layers calculated as described above through an external terminal or user input and determine a masking area in consideration of the information of the 1 of previous layers stored when generating a layer image.

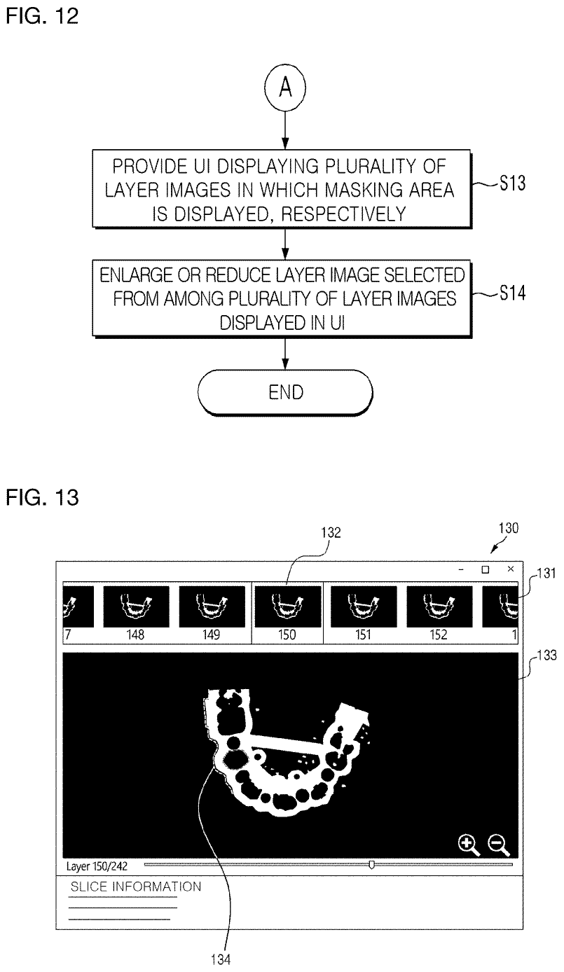

In the embodiment, referring to FIG. 12, the computing system 100 may additionally perform operations S13 to S14 after performing operation S12 described in FIG. 2 above.

In operation S13, the computing system 100 provides a UI that displays a plurality of layer images in which a masking area is displayed, respectively.

Next, in operation S14, the computing system 100 displays a layer image selected by a user input among the plurality of layer images displayed on the UI by enlarging or reducing the selected layer image. At this time, the masking area may be displayed so that the masking area is identifiable in the selected layer image.

For example, as illustrated in FIG. 13, when the masking area in which a gray scale value corresponding to the light exposure amount is designated for each layer is displayed, the computing system 100 may provide a screen interface 130 that shows all of the plurality of layer images in which the masking area is displayed. At this time, the screen interface 130 may display the plurality of layer images 131 at the top of the screen in a stiffening order from the left to the right, and the plurality of layer images 131 may be arranged so that the plurality of layer images 131 can be moved horizontally according to a user input. At this time, among the plurality of layer images 131 displayed at the top of the screen, a layer image 132 selected by the user may be enlarged and displayed at the bottom of the screen, and a masking area 134 may be displayed on an enlarged layer image 133. In addition, the enlarged layer image 133 may be reduced again and displayed according to a user input.

In the embodiment, the computing system 100 may display the previous layer images with respect to the selected layer image 132 among the plurality of layer images 131 displayed at the top of the screen interface 130 using a pop-up window 141. At this time, the previous layer images displayed in the pop-up window 141 may be the previous layer images irradiated to determine the masking area for the selected layer image 132.

According to the method of the present disclosure as described above, a plurality of layer images can be designed so that over-curing caused by UV light does not occur in the vicinity of the boundary of the layer at the time of output for each layer using a 3D printer by dental software. In addition, when a plurality of layer images for 3D printing are designed, a masking area where UV light transmission should be reduced for each layer can automatically be obtained through a comparison of the areas of the output areas of the current layer and the previous layers.

FIG. 15 is a block diagram illustrating hardware of a computing system according to another embodiment of the present disclosure.

The computing system 100 may include one or more processors 101, a bus 107, a network interface 102, a memory 103 that loads a computer program 105 executed by the processor 101, and a storage 104 that stores the computer program 105. The processor 101 controls the overall operation of each component of a patient management screen display device 100. The processor 101 may perform computation for at least one application or program for executing methods/operations according to various embodiments of the present invention. The memory 103 stores a variety of data, commands, and/or information. The memory 103 may load one or more computer programs 105 from the storage 104 to execute the methods/operations according to various embodiments of the present invention. The bus 107 provides a communication function between components of the patient management screen display device. The network interface 102 supports wired and wireless Internet communication of the patient management screen display device 100. The storage 104 may non-transitorily store one or more computer programs 105. The computer program 105 may include one or more instructions in which the methods/operations according to various embodiments of the present invention are implemented. When the computer program 105 is loaded into the memory 103, the processor 101 may perform the methods/operations according to various embodiments of the present invention by executing the one or more instructions.

In the embodiment, the computer program 105 may include instructions for performing operations of: determining and displaying a masking area of a current layer based on a non-overlapping area between a current layer and at least one previous layer among a plurality of layers designed to be sequentially stiffened in units of layers for 3D printing; and updating an image of the current layer by setting a light exposure amount of the masking area of the current layer.

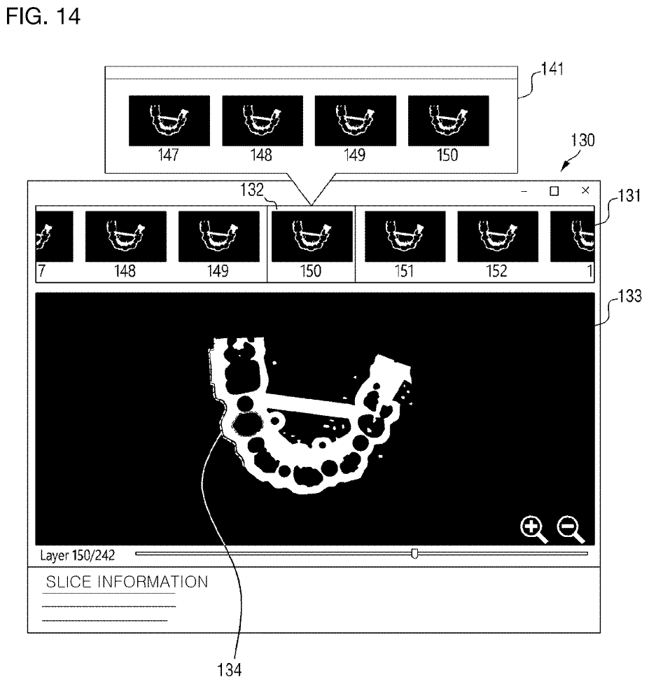

Heretofore, various embodiments of the present invention and effects according to the embodiments have been mentioned with reference to FIGS. 1 to 15. The effects according to the technical idea of the present invention are not limited to the effects mentioned above, and other effects not mentioned can be clearly understood by those skilled in the art based on the description below. The technical idea of the present invention described so far can be implemented as a computer-readable code on a computer-readable medium. The computer program recorded on the computer-readable recording medium may be transmitted to another computing device through a network, such as the Internet, and installed on the other computing device, thereby allowing the computer program to be used on the other computing device.

Although the operations are illustrated in a particular order in the drawings, it should not be understood that the operations must be performed in the particular illustrated order or in a sequential order or that all the illustrated operations must be performed to achieve desired results. In certain circumstances, multitasking and parallel processing may have advantages. Furthermore, the separation of the various components in the above-described embodiments should not be construed as necessarily requiring such separation, and it should be understood that the described program components and systems may generally be integrated together into a single software product or packaged into multiple software products.

Although embodiments of the present invention have been described with reference to the accompanying drawings, those skilled in the art to which the present invention pertains will understand that the present invention can be implemented in other specific forms without changing the technical spirit or essential characteristics. Therefore, it should be understood that the foregoing embodiments are not limited but are illustrative in all respects. The protection scope of the embodiments should be interpreted by the claims below, and all technical ideas within the scope equivalent thereto should be interpreted as being included in the scope of the embodiments.

What is claimed is:

1. A method of providing a layer image for 3D printing, which is performed by a computing system, the method comprising:
determining a masking area of a current layer based on a non-overlapping area between a current layer and at least one previous layer from among a plurality of layers; and
updating an image of the current layer by setting a light exposure amount with respect to the masking area of the current layer,
wherein the plurality of layers are designed to sequentially stiffen a photocurable material in a unit of each layer for 3D printing.

2. The method of claim 1, wherein the determining of the masking area of the current layer includes determining the masking area based on an area of the output area of the current layer that overlaps with a non-output area of the at least one previous layer.

3. The method of claim 1, wherein the determining of the masking area of the current layer includes determining the masking area based on a change in the expansion of the output area of the current layer compared to the output area of the at least one previous layer.

4. The method of claim 1, wherein the determining of the masking area of the current layer includes
setting at least a portion of the non-output area of the at least one previous layer as an over-curing area when the output area of the current layer protrudes further outward than the output area of the at least one previous layer, and
determining as the masking area an output area in which UV light transmitted through a corresponding output area from the output area of the current layer reaches the over-curing area of the at least one previous layer and causes curing.

5. The method of claim 1, wherein the determining of the masking area of the current layer includes determining the number of the at least one previous layers for determining the masking area.

6. The method of claim 5, wherein the determining of the number of the at least one previous layers for determining the masking area includes calculating the number of the at least one previous layers using a thickness of a material that is stiffened by a maximum light exposure amount and a stacking thickness corresponding to one layer.

7. The method of claim 1, wherein the updating of the image of the current layer includes setting as a predetermined grayscale value the light exposure amount with respect to the masking area of the current layer.

8. The method of claim 1, further comprising:
providing a UI that displays a plurality of layer images in which the masking area is displayed, respectively; and
displaying the layer image selected by a user input among the plurality of layer images displayed on the UI by enlarging or reducing the selected layer image while displaying the masking area in the selected layer image so that the masking area is identifiable.

9. A computing device comprising:
one or more processors;
a communication interface configured to communicate with an external device;
a memory configured to load a computer program executed by the processor; and
a storage configured to store the computer program,
wherein the computer program includes instructions for performing operations of:
determining a masking area of a current layer based on a non-overlapping area between a current layer and at least one previous layer from among a plurality of layers; and
updating an image of the current layer by setting a light exposure amount of the masking area of the current layer, wherein the plurality of layers are designed to sequentially stiffen a photocurable material in a unit of each layer for 3D printing.

10. The computing device of claim 9, wherein the determining of the masking aera of the current layer includes determining the masking area based on an area of the output area of the current layer that overlaps with a non-output area of the at least one previous layer.

11. The computing device of claim 9, wherein the determining of the masking aera of the current layer includes determining the masking area based on a change in the expansion of the output area of the current layer compared to the output area of the at least one previous layer.

12. The computing device of claim 9, wherein the determining of the masking area of the current layer includes
setting at least a portion of the non-output area of the at least one previous layer as an over-curing area when the output area of the current layer protrudes further outward than the output area of the at least one previous layer, and
determining as the masking area an output area in which UV light transmitted through a corresponding output area from the output area of the current layer reaches the over-curing area of the at least one previous layer and causes curing.

13. The computing device of claim 9, wherein the determining of the masking area of the current layer includes determining the number of the at least one previous layers for determining the masking area.

14. The computing device of claim 13, wherein the determining of the number of the at least one previous layers for determining the masking area includes calculating the number of the at least one previous layers using a thickness of a material that is stiffened by a maximum light exposure amount and a stacking thickness corresponding to one layer.

15. The computing device of claim 9, wherein the updating of the image of the current layer includes setting as a predetermined grayscale value the light exposure amount with respect to the masking area of the current layer.
